(19) United States
(12) Patent Application Publication
(10) Pub. No.: US 2020/0184498 A1
(43) Pub. Date: Jun. 11, 2020

(54) SYSTEMS AND METHODS FOR DESIGNING AND DEPLOYING WIRELESS COMMUNICATION MESH NETWORKS

(71) Applicants: Kevin Ross, Lehi, UT (US); Muhammad Ahsan Naim, South Jordan, UT (US)

(72) Inventors: Kevin Ross, Lehi, UT (US); Muhammad Ahsan Naim, South Jordan, UT (US)

(21) Appl. No.: 16/711,182

(22) Filed: Dec. 11, 2019

Related U.S. Application Data
(60) Provisional application No. 62/778,193, filed on Dec. 11, 2018.
(60) Provisional application No. 62/782,110, filed on Dec. 19, 2018.

(51) Int. Cl. G06Q 30/02; H04L 12/24; H04W 4/021; H04B 10/112; H04W 76/10; H04W 16/18

(52) U.S. Cl. CPC G06Q 30/0205; H04L 41/5003; H04W 4/021; H04W 84/18; H04W 76/10; H04W 16/18; H04B 10/112

(57) ABSTRACT

Disclosed herein are systems and methods that relate to wireless communication mesh network design and operation. In one aspect, the disclosed process may involve (1) obtaining potential-customer information related to a set of potential customers for a service to be provided through a wireless communication mesh network in an AOI, where the potential-customer information comprises both (i) information related to potential customers that are identified during a pre-marketing phase and (ii) information related to potential customers that are identified during a door-to-door marketing phase, and where the set of potential customers have a corresponding set of customer locations in the AOI, (2) evaluating the obtained potential-customer information and thereby identifying a subset of customer locations at which to deploy the wireless communication mesh network, and (3) generating and outputting information that facilitates deployment of the wireless communication mesh network at the identified subset of customer locations in the AOI.

### CROSS-REFERENCE TO RELATED APPLICATIONS

This application claims priority to (i) U.S. Provisional App. No. 62/778,193, filed Dec. 11, 2018, and entitled “METHODS FOR BUILDING WIRELESS MESH NETWORK,” and (ii) U.S. Provisional App. No. 62/782,110, filed Dec. 19, 2018, and entitled “METHODS FOR BUILDING WIRELESS MESH NETWORK,” each of which is incorporated herein by reference in its entirety.

### BACKGROUND

Wired and wireless networking and communications systems are widely deployed to provide various types of communication and functional features, including but not limited to those for high speed home internet, security and automation, and/or others. These systems may be capable of supporting communications with a user via a communication connection or a system management action.

Current wireless communication mesh network rollout approaches for fixed wireless access, especially for networks that have a very short point-to-point (“ptp”) and/or point-to-multipoint (“ptmp”) millimeter wave link length (e.g., 50-300 meters), involve fiber Point of Presence (“PoP”) site/node development, and seed home sites development that may involve establishing multiple long ptp/ptmp links from a fiber PoP site to a seed homes site. In turn, a line-of-sight (“LOS”) analysis is conducted from seed homes for the potential anchor homes (e.g., high speed internet fixed wireless customers) to identify potential customers, and marketing (including door-to-door sales for a small area) is conducted to build a ring or multiple rings of anchor homes for a wireless communication mesh network. Once, sales and/or installation of anchor homes that form a partial ring, a complete ring, or multiple rings is completed, next round of sales is commenced to target potential customers (LOS availability to the existing nodes) to extend the wireless communication mesh network (e.g., by adding additional anchor homes or rings to the newly-created portion of the wireless communication mesh network.

However, this current wireless communication mesh network rollout approach exhibits many shortcomings. As one example, this current rollout approach slows down the efficiency in designing and deploying a wireless communication mesh network, especially a wireless communication mesh network that is spread over a large geographical area (e.g., 10-20 sq. miles), because of the inherently sequential nature of the intermediary steps in marketing using door-to-door (direct-to-home) sales that is done at a mesh ring or cluster level rather than over a large portion of the intended coverage area of the wireless communication mesh network.

Thus, there exists a need in the art for improved systems and methods relating to wireless communication mesh network design and operation to make the rollout of a wireless communication mesh network more efficient.

### OVERVIEW

The present disclosure, for example, relates to wireless networks and communications including, but not limited to, broadband internet services to end users, security and/or automation systems, and more particularly to narrow beam mesh networking and related operations and techniques.

In accordance with the present disclosure, disclosed herein are systems and methods that relate to wireless communication mesh network design, installation, and deployment. In one aspect, the present systems and methods may involve a pre-marketing phase that includes various sub-phases, such as social media/online marketing, radio/television-based marketing, and mailer-based marketing, that can generate leads for potential customers (and/or their corresponding customer locations) that expressed interest in subscribing to an internet service based on a wireless communication mesh network. Based on these leads, an area of interest (“AOI”) is identified that is used for subsequent door-to-door marketing and sales. A door-to-door marketing/sales agent then uploads information about potential customers who signed an agreement to a computing system (e.g., a server or shared drive) or accesses a software application (e.g., a mobile application) to provide real-time information about potential customers (e.g., mesh network information associated with a given potential customer) to a network-planning engine. The software application may also receive information about potential customers from the pre-marketing phase and send the information to the network-planning engine.

Based on various criteria defined herein, the network-planning engine may then disqualify some potential customers (and/or their corresponding customer locations) and select the remaining potential customers (and/or their corresponding customer locations) for wireless communication mesh network installation/development. In some instances, through a feedback loop, the network-planning engine may convert a potential customer (and/or its respective location) from a disqualified status to a selected status or from a selected status to a disqualified status. Further, in some instances, the network-planning engine may also select among those potential customers (and/or their corresponding customer locations) that are not selected for wireless communication mesh network construction for a different tier of service that is built at a later phase. The different tier of service may include different technology, service-level agreement and/or equipment pricing.

In some instances, the network-planning engine may also interact with the door-to-door marketing phase when there is a need to find additional customers (and/or their corresponding customer locations) and add sites at their locations to build a complete wireless communication mesh network. The network-planning engine may also interact with a network installation/deployment phase that may involve a scheduling engine and an optimization engine that are both capable of performing various functions. For instance, based on a list of customer locations and the wireless communication mesh network layout, the scheduling engine (with the help of the optimization engine) may facilitate planning (e.g., on an hourly, daily, and/or weekly basis) the respective schedules of various installation teams working on different phases of the wireless communication mesh network installation/deployment, including electrical installation, line run, antenna mounting, ptp/ptmp node installation, alignment, provisioning, and/or customer service activation at a cluster level, among other examples.

One of ordinary skill in the art will appreciate that some of the foregoing phases can be omitted or can interact with various other phases in various ways or can take place in a different order.

In another aspect, the present systems and methods may involve identifying an AOI that is selected based on multiple factors that are described in more detail below. Based on the identified AOI, a pre-marketing phase that includes various sub-phases, such as social media/online marketing, radio/television-based marketing and mailer-based marketing, is executed to generate leads for potential customers (and/or their corresponding customer locations) that expressed interest in subscribing to an internet service based on a wireless communication mesh network. The disclosed process may then transition to a door-to-door marketing phase as described above.

Based on various criteria defined herein, a network-planning engine may then disqualify some potential customers (and/or their corresponding customer locations) and select the remaining potential customers (and/or their corresponding customer locations) for wireless communication mesh network installation/development. In some instances, through a feedback loop, the network-planning engine may convert a potential customer location from a disqualified status to a selected status and vice versa. Further, in some instances, the network-planning engine may also select among those potential customers (and/or their corresponding customer locations) that are not selected for wireless communication mesh network construction for a different tier of service that is built at a later phase. The different tier of service may include different technology, service-level agreement and/or equipment pricing.

In some instances, the network-planning engine may also interact with the door-to-door marketing phase when there is a need to find additional customers (and/or their corresponding customer locations) and add sites at their locations to build a complete wireless communication mesh network. The network-planning engine may also interact with a network installation/deployment phase that may involve a scheduling engine and an optimization engine that are both capable of performing various functions. For instance, based on a list of customer locations and the wireless communication mesh network layout, the scheduling engine (with the help of the optimization engine) may facilitate planning (e.g., on an hourly, daily, and/or weekly basis) the respective schedules of various installation teams working on different phases of the wireless communication mesh network installation/deployment, including electrical installation, line run, antenna mounting, ptp/ptmp node installation, alignment, provisioning, and/or customer service activation at a cluster level, among other examples.

One of ordinary skill in the art will appreciate that some of the foregoing phases can be omitted or can interact with various other phases in various ways or can take place in a different order.

Accordingly, in one aspect, disclosed herein is a method that involves (1) obtaining potential-customer information related to a set of potential customers for a service to be provided through a wireless communication mesh network in an AOI, where the potential-customer information comprises both (i) information related to potential customers that are identified during a pre-marketing phase and (ii) information related to potential customers that are identified during a door-to-door marketing phase, and where the set of potential customers have a corresponding set of customer locations in the AOI, (2) evaluating the obtained potential-customer information and thereby identifying a subset of customer locations at which to deploy the wireless communication mesh network, and (3) generating and outputting information that facilitates deployment of the wireless communication mesh network at the identified subset of customer locations in the AOI.

In another aspect, disclosed herein is a computing system that includes a network interface, at least one processor, a non-transitory computer-readable medium, and program instructions stored on the non-transitory computer-readable medium that are executable by the at least one processor to cause the computing system to carry out the functions of the foregoing method.

In yet another aspect, disclosed herein is a computing system that includes a network interface, at least one processor, a non-transitory computer-readable medium, and program instructions stored on the non-transitory computer-readable medium that are executable by the at least one processor to cause the computing system to carry out the functions including (1) obtaining potential-customer information related to a set of potential customers for a service to be provided through a wireless communication mesh network in an AOI, where the potential-customer information comprises both (i) information related to potential customers that are identified during a pre-marketing phase and (ii) information related to potential customers that are identified during a door-to-door marketing phase, where the set of potential customers have a corresponding set of customer homes in the AOI, and where the potential-customer information comprises a respective LOS profile for a roof overhang of each customer home in the set of customer homes, (2) based at least in part on the respective LOS profiles for the roof overhangs of the set of customer homes, identifying a subset of customer locations at which to deploy the wireless communication mesh network, and (3) generating and outputting information that facilitates deployment of the wireless communication mesh network at the identified subset of customer locations in the AOI.

In a further aspect, disclosed herein is a computing system that includes a set of wireless communication mesh network nodes that are configured to form a wireless communication mesh network, where each of at least a subset of the wireless communication mesh network nodes in the set of wireless communication mesh network nodes comprises a customer home having wireless communication mesh network equipment installed on a roof overhang of the customer home.

One of ordinary skill in the art will appreciate these as well as numerous other aspects in reading the following disclosure.

### BRIEF DESCRIPTION OF THE DRAWINGS

A further understanding of the nature and advantages the present disclosure may be realized by reference to the following drawings.

FIG. 1A depicts an example flow diagram for designing and deploying a wireless communication mesh network, in accordance with various aspects of this disclosure;

FIG. 1B depicts another example flow diagram for designing and deploying a wireless communication mesh network, in accordance with various aspects of this disclosure;

FIG. 2A depicts an example pre-marketing phase, in accordance with various aspects of this disclosure;

FIG. 2B depicts another example pre-marketing phase, in accordance with various aspects of this disclosure;

FIG. 3A depicts another example flow diagram for designing and deploying a wireless communication mesh network, in accordance with various aspects of this disclosure;

FIG. 3B depicts yet another example flow diagram for designing and deploying a wireless communication mesh network, in accordance with various aspects of this disclosure;

FIG. 4 depicts yet another example flow diagram for designing and deploying a wireless communication mesh network, in accordance with various aspects of this disclosure;

FIG. 5 depicts an example network installation/deployment phase, in accordance with various aspects of this disclosure;

FIG. 6 depicts another example network installation/deployment phase, in accordance with various aspects of this disclosure;

FIG. 7A depicts an example summary level flow diagram for designing and deploying a wireless communication mesh network, in accordance with various aspects of this disclosure;

FIG. 7B depicts another example summary level flow diagram for designing and deploying a wireless communication mesh network, in accordance with various aspects of this disclosure;

FIG. 8 depicts another example flow diagram for designing and deploying a wireless communication mesh network, in accordance with various aspects of this disclosure;

FIG. 9 depicts an example coverage area of a wireless communication mesh network as customers are added or removed, in accordance with various aspects of this disclosure; and

FIG. 10 depicts an example private infrastructure in which wireless communication mesh network equipment may be installed, in accordance with various aspects of this disclosure.

### DETAILED DESCRIPTION

In accordance with the present disclosure, disclosed herein are systems and methods that relate to wireless communication mesh network design and operation. The present systems and methods may involve various phases to construct a wireless communication mesh network, such as a pre-marketing phase, a door-to-door marketing phase, a planning phase, and a network installation/deployment phase, among other phases described in more detail herein.

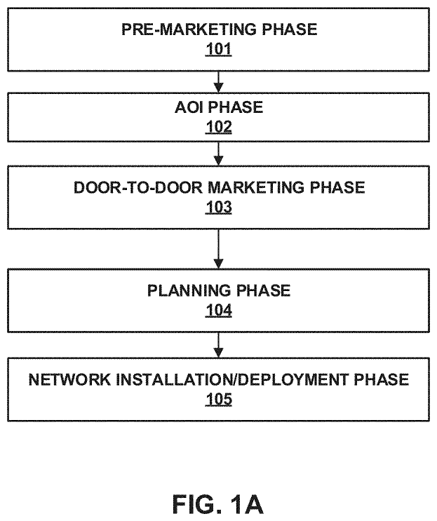

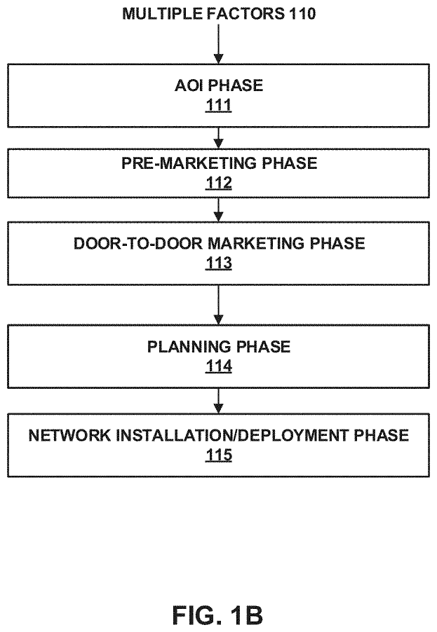

For instance, FIG. 1A depicts an example flow diagram for designing and deploying a wireless communication mesh network that may comprise point-to-point (“ptp”) and/or point-to-multipoint (“ptmp”) links. As shown in FIG. 1A, the example process may involve pre-marketing phase 101, which may involve generating leads for potential customers. Pre-marketing phase 101 may involve various marketing techniques, including but not limited to marketing techniques that do not require a salesperson to physically visit a potential customer's home for marketing.

As further shown in FIG. 1A, pre-marketing phase 101 may be followed by an area of interest (“AOI”) phase 102 that may involve defining an AOI (or multiple AOIs) for designing a wireless communication mesh network. In some instances, an AOI may be defined based on leads that were generated during pre-marketing phase 101 (e.g., a list of potential customers that expressed interest in subscribing to a wireless communication mesh network service).

The example process may then transition from AOI phase 102 to door-to-door marketing phase 103, which may involve a salesperson physically visiting a given potential customer's home to sign-up the given potential customer for a wireless communication mesh network service. Based on the leads generated from pre-marketing phase 101 and contracted customers in door-to-door marketing phase 103, a subset of customer locations may be selected as wireless communication mesh network nodes for designing a wireless communication mesh network during planning phase 104. In turn, the network installation/deployment phase 105 may involve wireless communication mesh network node installation based on the selected customer locations at planning phase 104.

In practice, each of the foregoing phases in FIG. 1A may be implemented in whole or in part by a computing system, which may comprise a network interface, at least one processor, data storage, and program instructions stored in the data storage that are executable by the at least one processor to perform one or more of the functions described above. Further, one of ordinary skill in the art will appreciate that such a computing system may carry out one or more of the functions described above based on user input. Further yet, one of ordinary skill in the art will appreciate that the example flow diagram shown in FIG. 1A may be altered to include more or less phases or can be rearranged in a different order.

Referring to FIG. 1B, another example flow diagram for designing and deploying a wireless communication mesh network is described herein. As shown, the example process may begin with consideration of multiple factors 110 that may lead to the selection of an AOI at AOI phase 111. Multiple factors 110 may include the availability of designing and deploying a wireless communication mesh network with fiber connectivity at a reasonable cost, a level of vegetation in the AOI, population density, demographics, and/or average annual household income, among other possible factors.

As further shown in FIG. 1B, after considering multiple factors 110, an AOI for designing and deploying a wireless communication mesh network may be selected at AOI phase 111, which is followed by pre-marketing phase 112. The example process may then transition from pre-marketing phase 112 to door-to-door marketing phase 113, which may involve a salesperson physically visiting a given potential customer's home to sign-up the given potential customer for a wireless communication mesh network service.

Based on the leads generated from pre-marketing phase 112 and contracted customers at door-to-door marketing phase 113, a subset of customer locations may be selected as wireless communication mesh network nodes for designing a wireless communication mesh network during planning phase 114. In turn, the network installation/deployment phase 115 may involve wireless communication mesh network node installation and deployment based on the selected customer locations at planning phase 114.

In practice, each of the foregoing phases in FIG. 1B may be implemented in whole or in part by a computing system, which may comprise a network interface, at least one processor, data storage, and program instructions stored in the data storage that are executable by the at least one processor to perform one or more of the functions described above. Further, one of ordinary skill in the art will appreciate that such a computing system may carry out one or more of the functions described above based on user input. Further yet, one of ordinary skill in the art will appreciate that the example flow diagram shown in FIG. 1B may be altered to include more or less phases or can be rearranged in a different order.

In general, the pre-marketing phase of the disclosed process for designing and deploying a wireless communication mesh network may take various forms and may involve various functions.

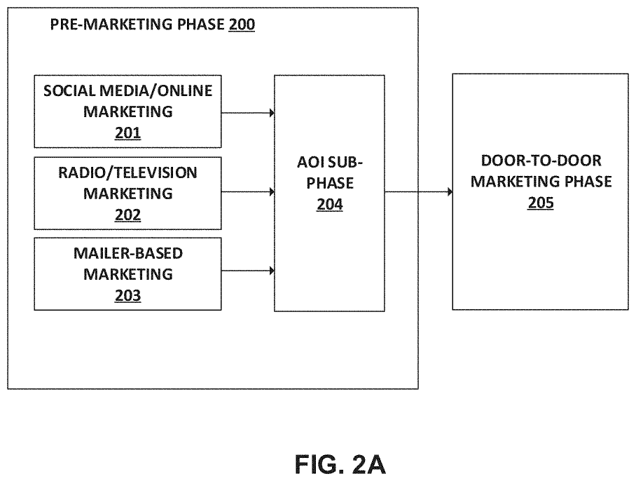

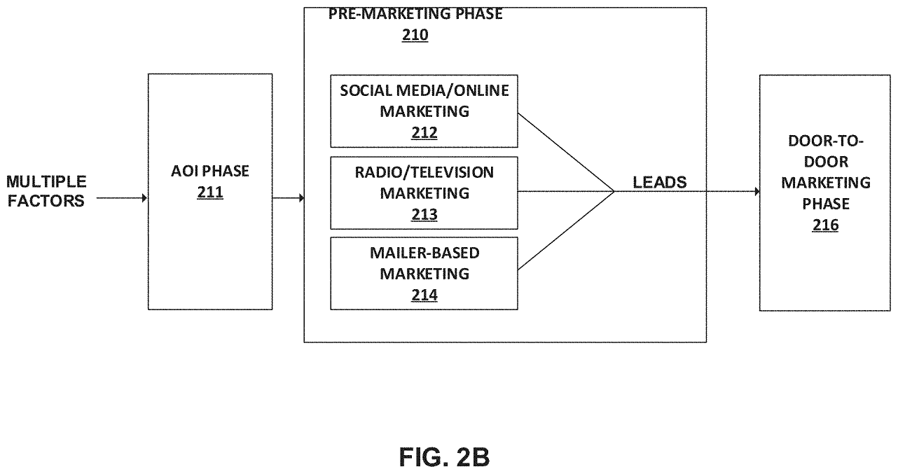

To illustrate, FIG. 2A depicts an example pre-marketing phase 200, which is followed by a door-to-door marketing phase 205. Generally speaking, the pre-marketing phase 200 may be similar to pre-marketing phase 101 of FIG. 1A. As shown, pre-marketing phase 200 may comprise a social media/online marketing sub-phase 201, a radio/television marketing sub-phase 202, and a mailer-based marketing sub-phase 203. As also shown, pre-marketing phase 200 may include an AOI sub-phase 204 where one or more AOIs are defined—although in line with the discussion above, it should be understood that an AOI phase may also be viewed as a separate phase from pre-marketing phase 200.

Social media/online marketing sub-phase 201 may take various forms. For instance, social media/online marketing sub-phase 201 may involve various techniques, including but not limited to search engine optimization, where mobile internet users and/or internet users at in-building locations are approached based on certain criteria. The criteria may include a particular region with certain population density, demographics (e.g., age group, income group, etc.), and/or ownership or residence in a certain type of housing, among other examples. In some instances, certain criteria other than the criteria described above may be used or blanket social media/online marketing may be used.

Radio/television marketing sub-phase 202 may take various forms as well. For instance, radio/television marketing sub-phase 202 may involve radio/television marketing in specific regions based on certain criteria. The criteria may include a particular region with certain population density, demographics (e.g., age group, income group, etc.), and/or ownership or residence in a certain type of housing, among other examples. In some instances, certain criteria other than the criteria described above may be used or blanket radio/television marketing may be used.

Likewise, mailer-based marketing sub-phase 203 may take various forms. For instance, mailer-based marketing sub-phase 203 may involve mailer-based marketing in specific regions based on certain criteria. The criteria may include a particular region with certain population density, demographics (e.g., age group, income group, etc.), and/or ownership or residence in a certain type of housing, among other examples. In some instances, certain criteria other than the criteria defined above may be used or blanket mailer-based marketing may be used.

As noted above, pre-marketing phase 200, which comprises social media/online marketing sub-phase 201, radio/television marketing sub-phase 202 and mailer-based marketing sub-phase 203, may generate leads for potential customers that are interested in subscribing to a wireless communication mesh network service. Based on the generated leads, one or more AOIs may be identified at AOI sub-phase 204, and these identified one or more AOIs may be later used during door-to-door marketing phase 205.

In practice, each of the foregoing phases in FIG. 2A may be implemented in whole or in part by a computing system, which may comprise a network interface, at least one processor, data storage, and program instructions stored in the data storage that are executable by the at least one processor to perform one or more of the functions described above. Further, one of ordinary skill in the art will appreciate that such a computing system may carry out one or more of the functions described above based on user input. Further yet, while sub-phases 201, 202 and 203 are shown to take place in parallel, it should be understood that a subset of these sub-phases can take place sequentially and may take any order. Still further, it should be understood that pre-marketing phase 200 may include more or less sub-phases shown in FIG. 2A.

Turning to FIG. 2B, another example pre-marketing phase 210 is described, which is followed by a door-to-door marketing phase 216 and is preceded by AOI phase 211 where one or more AOIs are determined based on multiple factors. As noted above, the multiple factors may include the availability of a fiber Point of Presence (“PoP”) building at a reasonable cost, line-of-sight (“LOS”) profile of the fiber PoP building (e.g., roof) to its surrounding area, population density, residential home density, demographics, and/or vegetation, among other examples.

Generally speaking, pre-marketing phase 210 in FIG. 2B may be similar to pre-marketing phase 112 of FIG. 1B. As shown in FIG. 2B, pre-marketing phase 210 may comprise a social media/online marketing sub-phase 212, radio/television marketing sub-phase 213, and a mailer-based marketing sub-phase 214. These sub-phases may take various forms similar to social media/online marketing sub-phase 201, radio/television marketing sub-phase 202, and mailer-based marketing sub-phase 203 of FIG. 2A. In this respect, pre-marketing phase 210 of FIG. 2B, which comprises social media/online marketing sub-phase 212, radio/television marketing sub-phase 213 and mail-based marketing sub-phase 214, may generate leads to potential customers that are interested in subscribing to a wireless communication mesh network service. As further shown in FIG. 2B, leads may be later used during door-to-door marketing phase 216.

In practice, each of the foregoing phases in FIG. 2B may be implemented in whole or in part by a computing system, which may comprise a network interface, at least one processor, data storage, and program instructions stored in the data storage that are executable by the at least one processor to perform one or more of the functions described above. Further, one of ordinary skill in the art will appreciate that such a computing system may carry out one or more of the functions described above based on user input. Further yet, while sub-phases 212, 213, and 214 are shown to take place in parallel, it should be understood that a subset of these sub-phases can take place sequentially and may take any order. Still further, it should be understood that pre-marketing phase 210 may include more or less sub-phases.

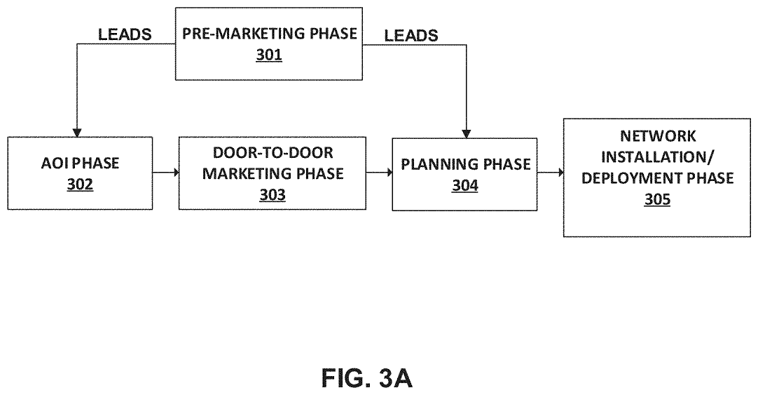

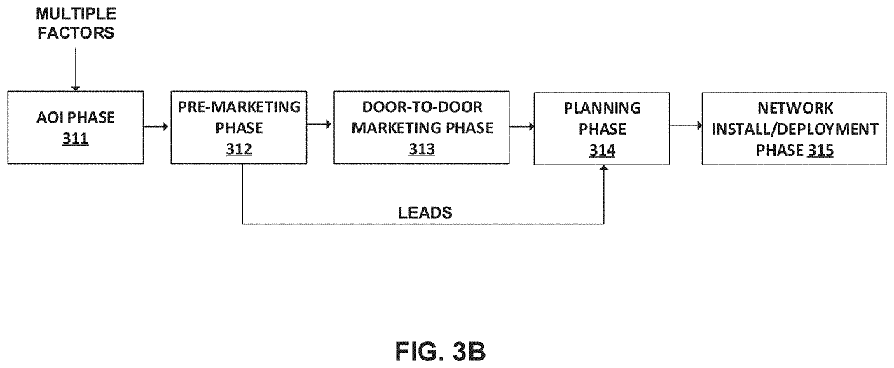

Turning to FIG. 3A, another example flow diagram for designing and deploying a wireless communication mesh network is described. As shown, FIG. 3A includes a pre-marketing phase 301 to generate leads for potential customers, an AOI phase 302, and a door-to-door marketing phase 303, each of which has been described previously. As noted above, door-to-door marketing phase 303 may involve a salesperson physically visit a potential customer's home for marketing and sales of wireless communication mesh network services.

As further shown, FIG. 3A also includes a planning phase 304. Planning phase 304 may involve receiving information about potential customers (e.g., an up-to-date list of potential customers and/or their corresponding customer locations/homes) that have shown interest in subscribing to a wireless-communication-mesh-network service from pre-marketing phase 301. Planning phase 304 may also involve receiving potential customer information from door-to-door marketing phase 303. Based on various factors, a wireless communication mesh network may then be designed at planning phase 304 by rejecting certain potential customers (and/or their corresponding customer locations/homes) among the received list of potential customers and selecting the remaining potential customers (and/or their corresponding customer locations/homes) for wireless communication mesh network installation/deployment. These factors may include the list of potential customers (and/or their corresponding customer locations), LOS profile (e.g., a number of surrounding homes a potential customer's home has a LOS path), vegetation profile, number of hops, length of link, target market penetration rate, number of service tiers, number of technology tiers, among other possible factors.

In turn, network installation and deployment may take place at a network installation/deployment phase 305, which may involve wireless communication mesh network node installation and deployment based on the selected customer locations at planning phase 304 as described above.

Turning to FIG. 3B, another example flow diagram for designing and deploying a wireless communication mesh network is described. As shown, FIG. 3B includes an AOI phase 311 that may involve determining one or more AOIs based on multiple factors, which may include the availability of a fiber PoP building at a reasonable cost, LOS profile of the building (e.g. roof) to its nearby surrounding area, population density, residential home density, demographics, and/or vegetation, among other possible factors. FIG. 3B also includes a pre-marketing phase 312 to generate leads for potential customers, a door-to-door marketing phase 313, a planning phase 314, and a network installation/deployment phase 315, each of which has been described above with respect to FIG. 3A and are described in more detail below.

In practice, each of the foregoing phases in FIGS. 3A-B may be implemented in whole or in part by a computing system, which may comprise a network interface, at least one processor, data storage, and program instructions stored in the data storage that are executable by the at least one processor to perform one or more of the functions described above. Further, one of ordinary skill in the art will appreciate that such a computing system may carry out one or more of the functions described above based on user input.

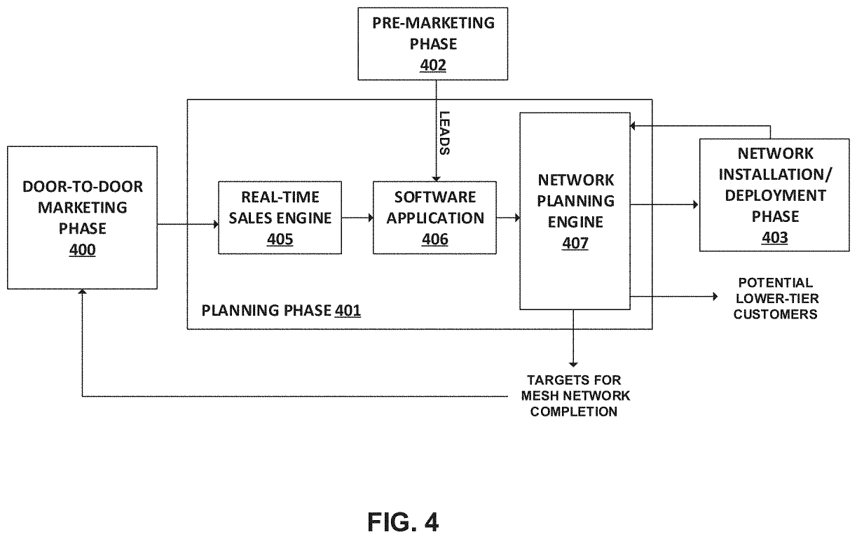

Turning to FIG. 4, another example flow diagram for designing and deploying a wireless communication mesh network is described. As shown, FIG. 4 includes various high-level phases, such as a door-to-door marketing phase 400, a planning phase 401, a pre-marking phase 402, and a network installation/deployment phase 403. As above, in practice, each of these phases may be implemented in whole or in part by a computing system, which may comprise a network interface, at least one processor, data storage, and program instructions stored in the data storage that are executable by the at least one processor to perform one or more of the described functions (perhaps based on user input).

Generally speaking, door-to-door marketing phase 400 may take various forms. For instance, as noted above, door-to-door marketing phase 400 may involve a salesperson physically visiting a potential customer's home for marketing and sales of wireless communication mesh network services. In some instances, door-to-door marketing and sales at door-to-door marketing phase 400 may be involve a salesperson physically visiting potential customer homes that are in a certain AOI. In other instances, door-to-door marketing phase 400 may involve blanket door-to-door marketing. Further, in some implementations, door-to-door marketing phase 400 may involve generating a list of potential customers that have shown interest in subscribing to a wireless communication mesh network service by signing a contractual agreement for the service.

During door-to-door marketing phase 400, information about interactions with potential customers may be collected and provided to a computing system that is involved in implementing planning phase 401. For example, after potential customers have signed a contractual agreement for the wireless communication mesh network service, the signed contracts may be uploaded to a data store that is included within or can otherwise be accessed by a computing system involved in implementing planning phase 401, such that information about the potential customers (e.g., customer location information) can be available to such a computing system.

As further shown in FIG. 4, planning phase 401 may be carried out via a real-time-sales engine 405, a software application 406, and a network-planning engine 407, each of which may take the form of program instructions that are executable by a computing system involved in implementing planning phase 401.

Real-time-sales engine 405 may generally function to receive information about potential customers that are identified during door-to-door marketing phase 400, where such information may be obtained in “real time” (i.e., during or shortly after the interaction with the potential customer takes place). In this respect, real-time-sales engine 405 may interface with client applications running on devices being used by the salespersons that are interacting with the potential customers during door-to-door marketing phase 400.

Further, software application 406 (e.g., a mobile application) may generally function to obtain information about potential customers (e.g., customer location information) that has been generated during door-to-door marketing phase 400 (which may be received via real-time-sales engine 405) as well as during pre-marking phase 402 (e.g., leads) and then provide potential-customer information to network-planning engine 407. In this respect, software application 406 may be an integral part in gathering and maintaining information about potential customers. (One of ordinary skill in the art will appreciate that software application 406 may interact with a data store that is configured to store the potential-customer information).

Further yet, network-planning engine 407 may generally function to receive potential-customer information from software application 406 and then perform an evaluation of such potential-customer information in order to identify and output information regarding a subset of potential customers (and/or their corresponding customer locations) for wireless communication mesh network installation/deployment.

For instance, network-planning engine 407 may function to reject certain potential customers (and/or their corresponding customer locations) from among a list of potential customers based on one or more factors and then select the remaining potential customers (and/or their corresponding customer locations) for wireless communication mesh network installation/deployment. These factors may include the list of potential customers (and/or their corresponding customer locations), LOS profile (e.g., a number of surrounding homes a potential customer's home has a LOS path), vegetation profile, number of hops, length of link, target market penetration rate, number of service tiers, number of technology tiers, among other possible factors.

Additionally, network-planning engine 407 may function to identify (and output information regarding) some potential customers (and/or their corresponding customer locations) from among a list of potential customers for a different tier of service provided through the wireless communication mesh network (e.g., a lower tier internet service) based on similar criteria described above if their homes are not suitable or ideal for primary wireless communication mesh network services. In this respect, the potential customers that are identified for the different tier of service may be the potential customers that are rejected based on the one or more factors described above, or some other subset of potential customers. The potential customers that are identified for the different tier of service by network-planning engine 407 may then be used to design a different tier for the wireless communication mesh network that may comprise a different wireless communication mesh network technology, a different Service Level Agreement (“SLA”), and/or a different pricing model.

Additionally yet, network-planning engine 407 may function to identify (and output information regarding) specific areas where customers are needed to complete and/or expand the wireless communication mesh network. These areas may include potential customers that were not identified during pre-marketing phase 402 or door-to-door marketing phase 400. The identification of the specific areas where customers are needed to complete and/or expand the wireless communication mesh network may then trigger a fresh round of door-to-door marketing focusing on customers in the identified area.

Network-planning engine 407 may take various other forms and may carry out various other functions as well.

After network-planning engine 407 outputs information about potential customers (and/or their corresponding customer locations) that have been identified for wireless communication mesh network installation/deployment, network installation and deployment may take place at network installation/deployment phase 406. Network installation/deployment phase 406 may take various forms.

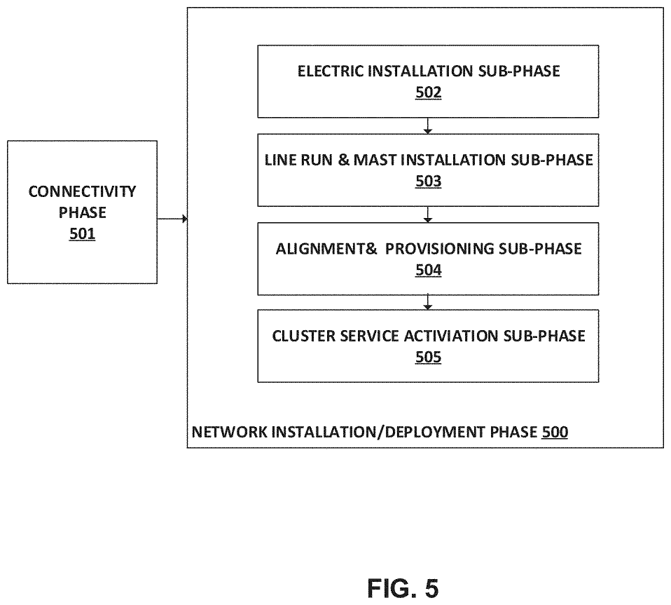

To illustrate, FIG. 5 depicts an example network installation/deployment phase 500. As shown, a wireless communication mesh network site (e.g., a tall building) that has fiber connectivity and ultimately connects a wireless communication mesh network to a CORE network and/or data center may be constructed at connectivity phase 501 that precedes network installation/deployment phase 500. In turn, network installation and deployment of wireless communication mesh network nodes may then take place at network installation/deployment phase 500, which may involve installing wireless communication mesh network equipment on a rooftop of a customer's home.

As further shown in FIG. 5, network installation/deployment phase 500 may comprise various sub-phases. For instance, network installation/deployment phase 500 may comprise an electrical installation sub-phase 502, which may involve installing a power box on the side of a customer's home along an exterior wall (or any other appropriate location) to provide power to telecommunication equipment of the wireless communication mesh network. Additionally, network installation/deployment phase 500 may comprise a line-run-and-antenna-mast installation sub-phase 503 that may involve installation of a line run and mast along with actual mounting of ptp/ptmp equipment. Additionally yet, network installation/deployment phase 500 may comprise an alignment-and-provisioning sub-phase 504 that may involve (1) aligning antennas of wireless communication mesh network equipment to ensure LOS connectivity between a node of one customer home with the node of another nearby customer home and establish a LOS-based ptp or ptmp link, and (2) configuring network settings of the ptp or ptmp nodes to ensure end-to-end connectivity from a customer home to a CORE network or data center.

It should be noted that, in some instances, sub-phases 502 to 504 of FIG. 5 may not involve any installation inside a customer's home and installation may be performed without the need for customers to be present at their homes.

As further shown in FIG. 5, network installation/deployment phase 500 may also comprise a cluster-service-activation sub-phase 505 that may involve installing routers inside customer homes to connect a wireless communication mesh network node installed at a customer home's roof-top to network devices of the customer and provide interne connectivity. Generally speaking, cluster-service-activation sub-phase 505 may typically require customers to be present in their homes, unlike sub-phases 502-504. Installation at cluster-service-activation sub-phase 505 may be performed after building and testing a complete ring (or several rings) forming a cluster of nodes for the wireless communication mesh network.

While FIG. 5 shows sub-phases 502-505 of network installation/deployment phase 500 taking place in a sequential manner, it should be understood that in other embodiments, some or all of these subphases may take place in parallel.

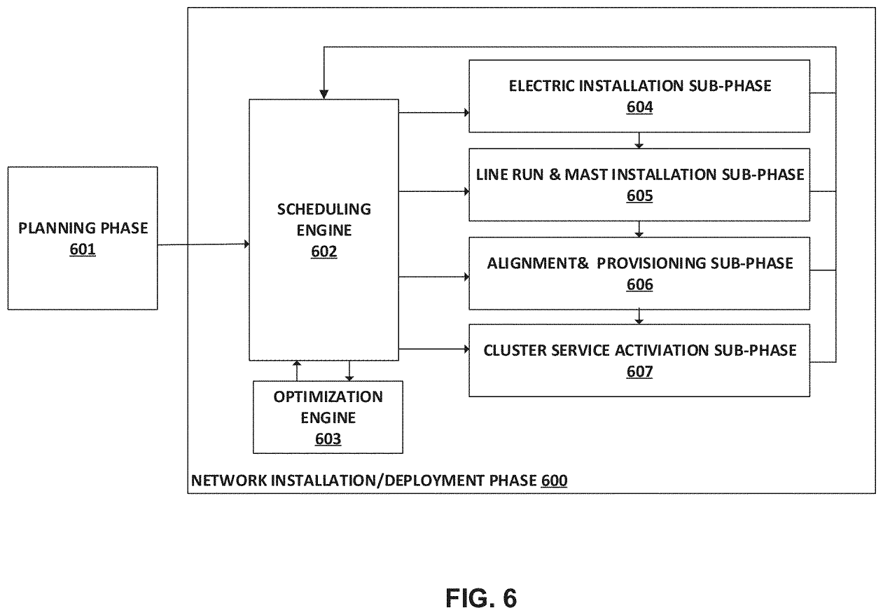

Referring to FIG. 6, another example network installation/development phase 600 for a wireless communication mesh network is shown. In FIG. 6, network installation/development phase 600 includes a scheduling engine 602, which may take the form of program instructions that are executable by a computing system involved in implementing network installation/deployment phase 600.

Scheduling engine 602 may generally function to receive a task from a planning phase 601, which may take a similar form to the planning phases that have been described above. For instance, planning phase 601 may provide scheduling engine 602 with a list of potential customers (and/or their corresponding customer locations) and may also provide wireless communication mesh network design information that defines how ptp/ptmp nodes should be connected between the customer locations (for antenna alignment and selection of a region on a roof of a customer home for antenna mounting). Based on such information, scheduling engine 602 may schedule different network installation teams for various sub-phases of network installation/deployment phase 600, which may include an electric-installation sub-phase 604, a line-run-and-mast installation sub-phase 605, an alignment-and-provisioning subphase 607, and a cluster-service-activation subphase 608, where each of these sub-phases may take similar forms to the respective sub-phases described above with respect to FIG. 5.

As further shown, in some embodiments, scheduling engine 602 may interact with an optimization engine 603, which may likewise take the form of program instructions that are executable by a computing system involved in implementing network installation/deployment phase 600. Optimization engine 603 may generally function to optimize the scheduling of subphases 604-608. For instance, in one implementation, optimization engine 603 may apply an artificial intelligence-based technique (e.g., simulated annealing) to devise a daily/weekly plan for network installation teams that optimizes the route between wireless communication mesh network customer locations. Further, in some instances, based on real-time feedback information from sub-phases 604-608 (which could be provided to optimization engine 603 via scheduling engine 602), optimization engine 603 may instruct scheduling engine 602 to change the scheduling of sub-phases 604-608 to optimize the installation process.

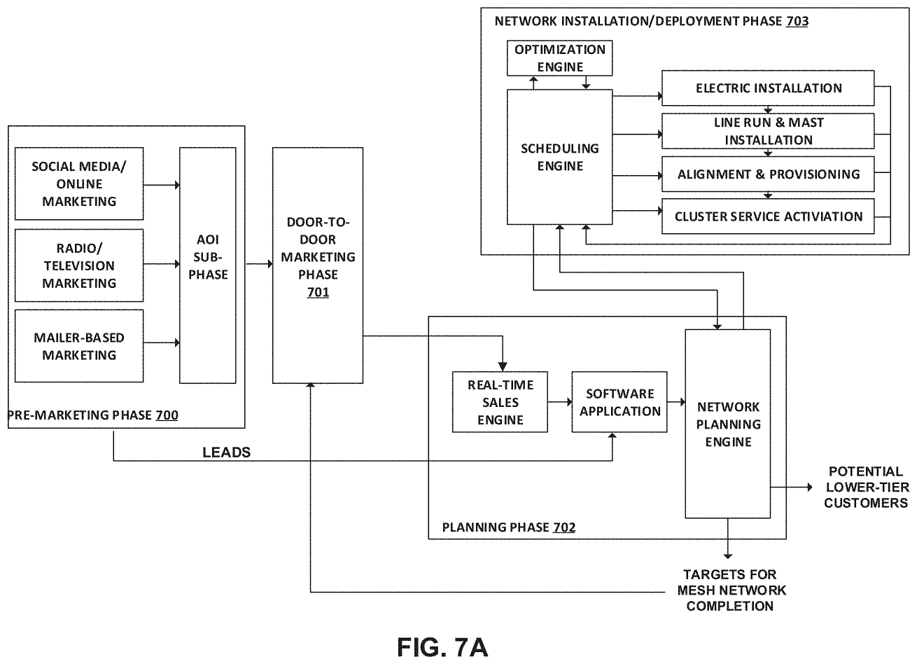

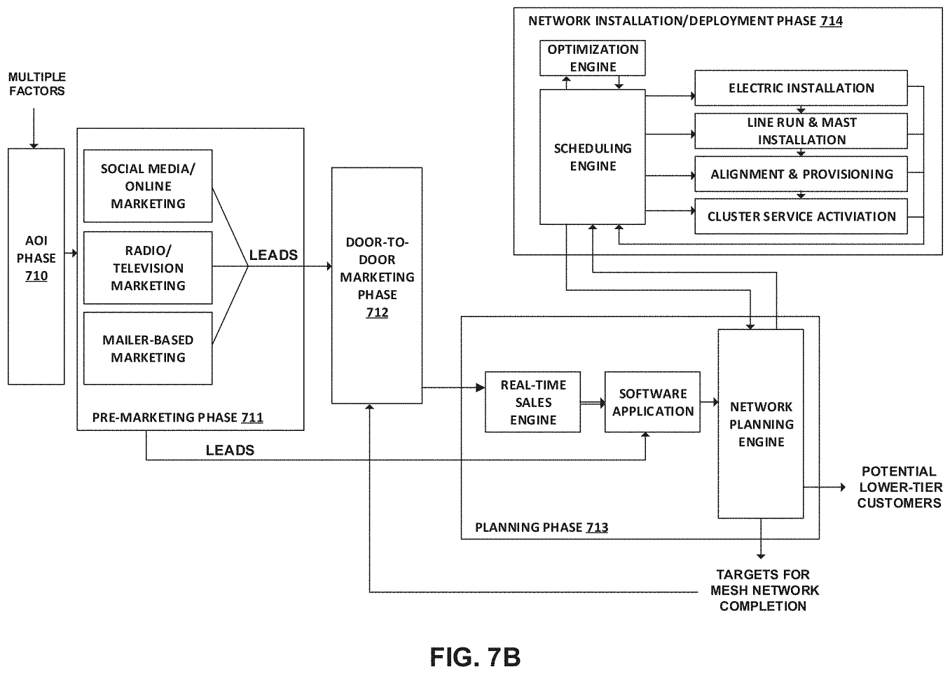

Referring to FIG. 7A, an example summary-level flow diagram for designing and deploying a wireless communication mesh network is shown to include various phases that have been described above. As above, in practice, each of these phases may be implemented in whole or in part by a computing system, which may comprise a network interface, at least one processor, data storage, and program instructions stored in the data storage that are executable by the at least one processor to perform one or more of the described functions (perhaps based on user input).

As shown, FIG. 7A comprises a pre-marketing phase 700 that may include sub- phases for social media/online marketing, radio/television-based marketing, and mailer-based marketing, and may involve generating leads for potential customers that have expressed interest in subscribing to a wireless communication mesh network service. Based on the generated leads, one or more AOIs may then be identified at an AOI sub-phase of pre-marketing phase 700, which may in turn be used at a door-to-door marketing phase 701.

During door-to-door marketing phase 701, information about interactions with potential customers may be collected and provided to a computing system that is involved in implementing planning phase 702. For instance, during door-to-door marketing phase 701, a door-to-door salesperson may upload information about potential customers who have signed a contractual agreement for the wireless communication mesh network service to a data store that is included within or can otherwise be accessed by a computing system involved in implementing planning phase 702, such that information about the potential customers (e.g., customer location information) can be available to such a computing system. In turn, during planning phase 702, a software application (e.g., a mobile application) may function to (i) obtain information about potential customers that has been generated during door-to-door marketing phase 701 (e.g., information that has been received in real-time) and/or information about potential customers that has been generated during pre-marketing phase 700 and (ii) send such information to a network-planning engine of planning phase 702.

Based on various criteria described above, the network-planning engine of planning phase 702 may then output various information. For example, the network-planning engine may disqualify some potential customers (and/or their corresponding customer locations), select the remaining customers (and/or their corresponding customer locations) for wireless communication mesh network installation/deployment, and then output information about the selected customers. Through a feedback loop, the network-planning engine may also convert a potential customer from a disqualified status to a selected status or vice versa.

As another example, the network-planning engine may select some potential customer locations (e.g., homes) among those potential customer locations that were not selected for wireless communication mesh network construction for a different tier of service that may be built at a later phase, and then output information about these potential customer locations. As noted above, the different tier of service may comprise different technology, SLA, and/or equipment pricing.

As yet another example, the network-planning engine may identify (and output information about) potential customer locations that may be used as wireless communication mesh network sites to complete and/or expand the wireless communication mesh network and then interact with door-to-door marketing phase 701 if there is a need to complete and/or expand the wireless communication mesh network.

As further shown in FIG. 7A, based on the list of customer locations and mesh network layout, the network-planning engine of planning phase 702 may also interact with a network installation/deployment phase 703 that includes a scheduling engine and an optimization engine to facilitate planning (e.g., on an hourly/daily/weekly basis) schedules of various installation teams involved in various subphases of network installation/deployment phase 703, including electrical installation, line run, antenna mounting, ptp/ptmp node installation, alignment and provisioning, and cluster service activation.

One of ordinary skill in the art will appreciate that FIG. 7A may involve more or less phases and/or sub-phases and that some of the phases and/or sub-phases may be arranged in a different manner.

Referring to FIG. 7B, another example summary-level flow diagram for designing and deploying a wireless communication mesh network is shown to include various phases that have been described above. As above, in practice, each of these phases may be implemented in whole or in part by a computing system, which may comprise a network interface, at least one processor, data storage, and program instructions stored in the data storage that are executable by the at least one processor to perform one or more of the described functions (perhaps based on user input).

As shown, the example flow diagram may begin with an AOI phase 710 that identifies an AOI based on multiple factors described above. Based on the identified AOI, leads for potential customers that have expressed interest in subscribing to a wireless communication mesh network service may be generated at a pre-marketing phase 711 that may include a social media/online marketing sub-phase, radio/television-based marketing sub-phase, and a mailer-based marketing sub-phase.

As further shown in FIG. 7B, the generated leads may be provided to a door-to-door marketing phase 712, which may then interact with a planning phase 713. For instance, during door-to-door marketing phase 712, a door-to-door salesperson may upload information about potential customers who have signed a contractual agreement for the wireless communication mesh network service to a data store that is included within or can otherwise be accessed by a computing system involved in implementing planning phase 702, such that information about the potential customers (e.g., customer location information) can be available to such a computing system. In turn, during planning phase 713, a software application (e.g., a mobile application) may function to (i) obtain information about potential customers that has been generated during door-to-door marketing phase 712 (e.g., information that has been received in real-time) and/or information about potential customers that has been generated during pre-marketing phase 711 and (ii) send such information to a network-planning engine of planning phase 713.

Based on various criteria described above, the network-planning engine of planning phase 713 may then output various information. For example, the network-planning engine may disqualify some potential customers (and/or their corresponding customer locations), select the remaining customers (and/or their corresponding customer locations) for wireless communication mesh network installation/deployment, and then output information about the selected customers. Through a feedback loop, the network-planning engine may also convert a potential customer from a disqualified status to a selected status or vice versa.

As another example, the network-planning engine may select some potential customer locations among those potential customer locations that were not selected for wireless communication mesh network construction for a different tier of service that may be built at a later phase, and then output information about these potential customer locations. As noted above, the different tier of service may comprise different technology, SLA, and/or equipment pricing.

As yet another example, the network-planning engine may identify (and output information about potential customer locations that may be used as wireless communication mesh network sites to complete and/or expand the wireless communication mesh network and then interact with door-to-door marketing phase 712 if there is a need to complete and/or expand the wireless communication mesh network.

As further shown in FIG. 7B, based on the list of customer locations and mesh network layout, the network-planning engine of planning phase 713 may also interact with a network installation/deployment phase 714 that includes a scheduling engine and an optimization engine to facilitate planning (e.g., on an hourly/daily/weekly basis) schedules of various installation teams involved in various sub-phases of network installation/deployment phase 714, including electrical installation, line run, antenna mounting, ptp/ptmp node installation, alignment and provisioning, and cluster service activation.

One of ordinary skill in the art will appreciate that FIG. 7B may involve more or less phases and/or sub-phases and that some of the phases and/or sub-phases may be arranged in a different manner.

In accordance with the present disclosure, the disclosed process for designing and deploying a wireless communication mesh network may take various other forms.

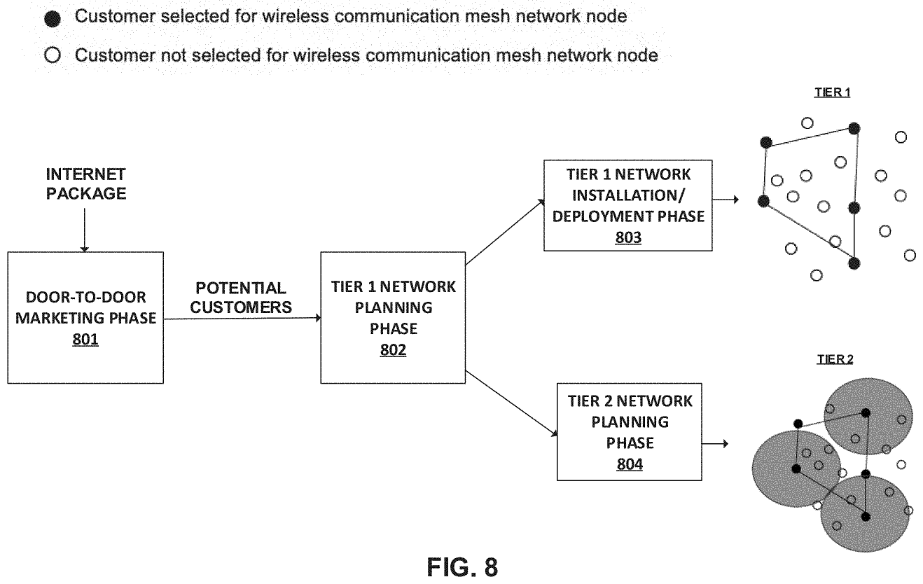

Referring now to FIG. 8, another example flow diagram for designing and deploying a wireless communication mesh network is shown. As above, in practice, each of the phases shown in FIG. 8 may be implemented in whole or in part by a computing system, which may comprise a network interface, at least one processor, data storage, and program instructions stored in the data storage that are executable by the at least one processor to perform one or more of the described functions (perhaps based on user input).

As shown in FIG. 8, information about an internet package, such as details regarding an internet service of the wireless communication mesh network (e.g., the uplink and downlink speed ranges, pricing, contract term, and/or options for bundling with other services, among other details), may be used for marketing at a marketing phase 801. In this respect, marketing phase 801 may comprise a pre-marketing phase and/or a door-to-door marketing phase that results in a list of potential customers for the wireless communication mesh network service. The potential customers may then be provided to a network-planning engine of a tier-1 network planning phase 802 as shown in FIG. 8, which may take a form similar to the network-planning engine described above with respect to FIGS. 7A-7B.

After the network-planning engine of tier-1 network planning phase 802 identifies customers and/or corresponding customer locations for construction of tier 1 of the wireless communication mesh network and outputs information about the identified customers/locations, installation and deployment of tier 1 of the wireless communication mesh network may then take place during a tier-1 network installation/deployment phase 803. As shown in FIG. 8, solid black circles represent potential customer locations that were selected as tier-1 wireless communication mesh network nodes during tier-1 network planning phase 802 and white circles represent potential customer locations that were not selected as tier-1 wireless communication mesh network nodes during tier-1 network planning phase 802.

In some instances, the SLA and pricing model for these customer locations selected as tier-1 wireless communication mesh network nodes may be different than the advertised internet package details from the internet package phase. For example, customer locations selected as tier-1 wireless communication mesh network nodes may be offered higher uplink and downlink speeds at a lower monthly fee or no monthly fee. In some instances, internet service fees may be waived or lowered only if customer locations selected as wireless communication mesh network nodes choose a bundled package that include other services, such as a smart home security service or a solar energy service. In other instances, the SLA and pricing model for these customer locations selected as tier-1 wireless communication mesh network nodes may remain unchanged from the advertised internet package details from the internet package phase.

Further, during a tier-2 network planning phase 804, some of the customer locations selected as tier-1 wireless communication mesh network nodes (represented by the solid black circles) may further be selected to provide a backbone for a wireless communication mesh network that has the capability to provide a different tier of services (e.g., “tier 2”) to other customer locations that were not selected as tier-1 wireless communication mesh network nodes during tier-1 network planning phase 802 (represented by the white circles). In turn, additional hardware may be added to these customer locations in order to design and deploy such a wireless communication mesh network. As shown in FIG. 8, in some embodiments, the additional hardware may provide an omni-directional coverage area for the different tier of services. In other embodiments, the additional hardware may provide a directional (e.g., 45-degree, 90-degree, 120-degree sector) coverage area for the different tier of services.

Based on the coverage area, at least some of the potential customer locations that were not selected as tier-1 wireless communication mesh network nodes (represented by white circles) may then be offered the different tier of services (e.g., “tier 2”) by installing wireless network equipment at their corresponding customer locations that are compatible with the wireless communication mesh network technology of the different tier, such as 4G LTE/LTE-Advanced, or Wi-Fi Aps. In one embodiment, the SLA and pricing for these tier-2 customers (represented by white circles) may be the same as the internet package details from the internet package phase. In another embodiment, the SLA and pricing for these customers may be different than the internet package details from the internet package phase.

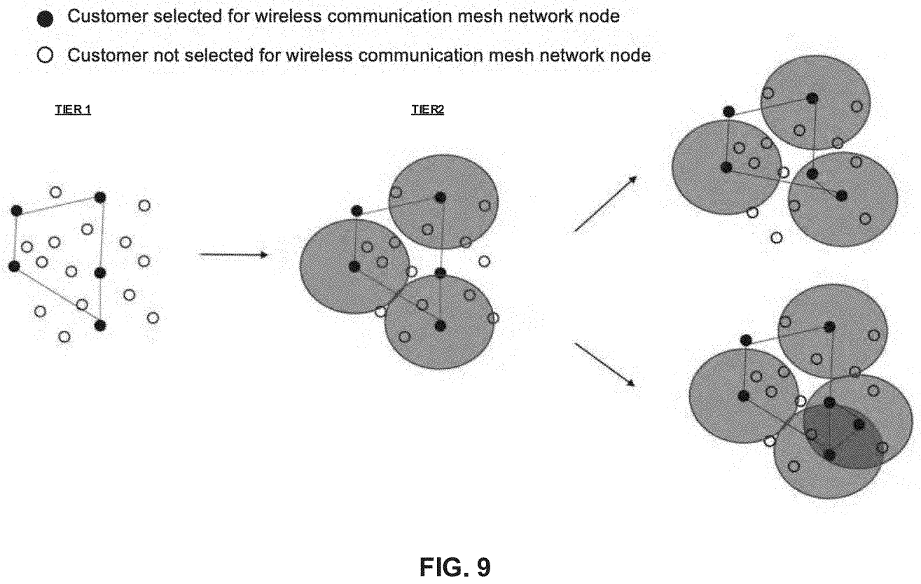

In practice, these tier-2 customers may be added to the wireless communication mesh network by adding wireless communication mesh network node equipment and creating ptp/ptmp links to connect the equipment to existing nodes of the wireless communication mesh network. Generally speaking, these tier-2 customers may be added to a wireless communication mesh network under various circumstances as illustrated in FIG. 9. For example, it is possible that an existing customer location selected as a tier-1 wireless communication mesh network node may unsubscribe from the wireless communication mesh network, which may cause the cover area for the different tier of services to change. As another example, it may be desirable to increase the coverage area of the wireless communication mesh network and/or expand the use of the tier-2 wireless communication mesh network technology by adding more tier-2 customers to the wireless communication mesh network. As yet another example, it may be desirable to increase the number of wireless communication mesh network customers. These tier-2 customers may be added to a wireless communication mesh network under various other circumstances as well.

In practice, for wireless communication mesh networks described above, private infrastructure, such as a single-family home rooftop may be used for deployment of wireless communication mesh network equipment (including antennas, antenna mounts, radios, cables, etc.) for ptp/ptmp links and wireless/cellular communication network small cells and CPEs. In this respect, the location on the rooftop where the communication network equipment is mounted can be very important. While field technicians and installers do their best to ensure no damage to the rooftop where the equipment are installed, the process of installing the equipment (e.g., drilling) may cause some possible damage to the rooftop in the longer run. In this respect, if the rooftop area selected for wireless network equipment installation is above a living area (e.g., a living room, bedroom, attic) or any other area, the liability of a network operator may be greatly increased by any damage caused by the installation. Accordingly, choosing an area of a roof for equipment installation that is not above any living space may greatly reduce the liability of a network operator that uses private infrastructure for network installation/deployment.

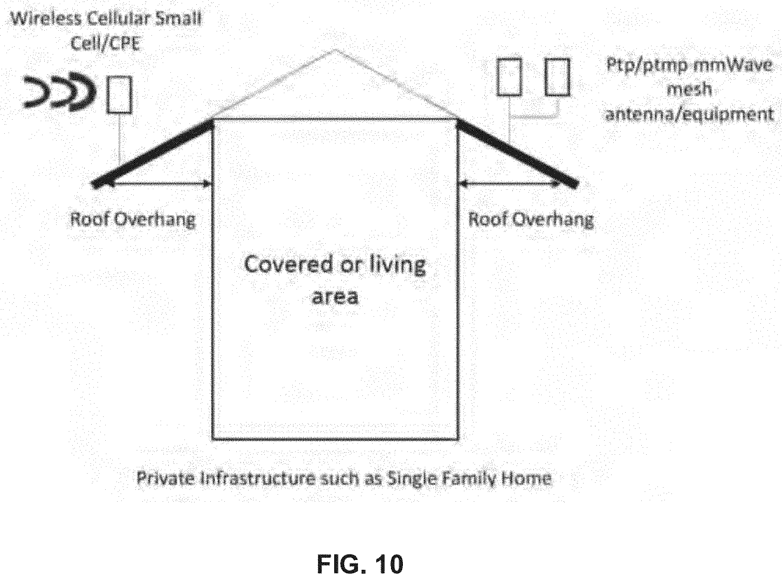

One such area may be the roof overhangs as shown in the FIG. 10. As shown, all wireless communication mesh network equipment may be installed on roof overhangs, and thus, any potential roof damage from installation is unlikely to impact a living area of a private infrastructure, such as a single-family home, and significantly reduce a wireless operator's liability.

In accordance with the present disclosure, a network-planning engine described above may use various criteria described above for selecting customers for the wireless communication mesh network and outputting information about the selected customers such that wireless communication mesh network nodes can be installed/deployed at the selected customer locations. In particular, the LOS profile may be an important criteria for designing and deploying a wireless communication mesh network to ensure that every wireless communication mesh network node (and the equipment on every rooftop) has a direct LOS path with other existing and future wireless communication mesh network nodes (neighbor sites), since wireless signals suffer very high level of attenuation if encountered with vegetation and/or buildings and ptp/ptmp links may drop due to weak signal levels.

In general, a LOS profile is dependent on the area of roof selected for LOS analysis. For example, one node can have a perfect LOS path to an existing (or future) neighbor node equipment from the highest point of the roof (which is typically above a living area) and may not have a LOS path to the same neighbor node equipment if the equipment is moved to a different section of the roof such as the roof overhangs as described above with respect to FIG. 10. In this respect, a customer home selected as a wireless communication mesh network node by installing equipment on top of the customer home's roof for setting up ptp/ptmp links may later cause large liability issues for a network operator.

Thus, in one embodiment, the network-planning engine of a planning phase (which has been described above) may select customer homes that have a good LOS profile with other wireless communication mesh network nodes from an area of a roof that is not directly above any living area and reject potential customers that do not have a good LOS profile with other wireless communication mesh network nodes (including existing and future/planned nodes) from the area the roof that is not directly above any living area. As described above with respect to FIG. 10, the area of the roof that is not directly above any living area may comprise the roof overhang. In some embodiments, the area of the roof that is not directly above any living area may comprise a different area other than the roof overhang as well.

Example embodiments of the disclosed innovations have been described above. Those skilled in the art will understand, however, that changes and modifications may be made to the embodiments described without departing from the true scope and spirit of the present invention, which will be defined by claims.

Further, to the extent that examples described herein involve operations performed or initiated by actors, such as humans, operators, users or other entities, this is for purposes of example and explanation only. Claims should not be construed as requiring action by such actors unless explicitly recited in claim language.

What is claimed is:

1. A computing system comprising:
a network interface;
at least one processor;
a non-transitory computer-readable medium; and
program instructions stored on the non-transitory computer-readable medium that are executable by the at least one processor such that the computing system is configured to:
obtain potential-customer information related to a set of potential customers for a service to be provided through a wireless communication mesh network in an area of interest (AOI), wherein the potential-customer information comprises both (i) information related to potential customers that are identified during a pre-marketing phase and (ii) information related to potential customers that are identified during a door-to-door marketing phase, and wherein the set of potential customers have a corresponding set of customer locations in the AOI;
evaluate the obtained potential-customer information and thereby identify a subset of customer locations at which to deploy the wireless communication mesh network; and
generate and output information that facilitates deployment of the wireless communication mesh network at the identified subset of customer locations in the AOI.

2. The computing system of claim 1, wherein the AOI for the wireless communication mesh network is identified based on leads generated during the pre-marketing phase.

3. The computing system of claim 1, wherein the AOI for the wireless communication mesh network is identified based on one or more of (i) availability of fiber connectivity at a reasonable cost, (ii) level of vegetation, (iii) population density, (iv) demographics, or (v) average annual household income.

4. The computing system of claim 1, wherein the pre-marketing phase comprises one or more of a social media or online marketing phase, a radio and television marketing phase, or a mailer-based marketing phase.

5. The computing system of claim 1, wherein the pre-marketing phase involves approaching individuals that are selected based on one or more of a population density, demographics, or association with a given type of housing.

6. The computing system of claim 1, wherein the potential customers that are identified during the door-to-door marketing phase comprise potential customers that have signed contracts for the service to be provided through the wireless communication mesh network.

7. The computing system of claim 1, wherein the door-to-door marketing phase comprises one or both of (i) blanket door-to-door marketing or (ii) targeted door-to-door marketing for a targeted set of potential customers in the AOI.

8. The computing system of claim 1, wherein the program instructions stored on the non-transitory computer-readable medium that are executable by the at least one processor such that the computing system is configured to evaluate the obtained potential-customer information and thereby identify the subset of customer locations at which to deploy the wireless communication mesh network comprise program instructions stored on the non-transitory computer-readable medium that are executable by the at least one processor such that the computing system is configured to:
evaluate one or more of a line-of-sight profile, a vegetation profile, a number of hops, a length of link, a target-market-penetration rate, a number of service tiers, or a number of technology tiers associated with each customer location included in the set of customer locations; and
based on the evaluation, reject certain customer locations in the set of customer locations and then identify each remaining customer location in the set of customer locations as a customer location to include in the subset of customer locations.

9. The computing system of claim 8, further comprising program instructions stored on the non-transitory computer-readable medium that are executable by the at least one processor such that the computing system is configured to:
identify the rejected potential customers as candidates for a different tier of the service to be provided through the wireless communication mesh network that is defined by a different type of wireless-communication-mesh-network technology, a different Service Level Agreement (SLA), or a different pricing model.

10. The computing system of claim 1, further comprising program instructions stored on the non-transitory computer-readable medium that are executable by the at least one processor such that the computing system is configured to:
after identifying the subset of customer locations at which to deploy the wireless communication mesh network, identify one or more locations where additional customers are needed in order to complete the wireless communication mesh network; and
identify potential customers at the identified or more locations, wherein the identified potential customers are not included in the set of potential customers.

11. The computing system of claim 1, wherein deployment of the wireless communication mesh network involves constructing a wireless communication network site that has fiber connectivity and connects the wireless communication mesh network to a data center.

12. The computing system of claim 1, wherein deployment of the wireless communication mesh network involves, for each respective customer location in the identified subset of customer locations, (i) installing power equipment to provide power to wireless-communication-mesh-network equipment, (ii) installing wireless-communication-mesh-network equipment comprising an antenna to establish a communication node at the respective customer location, (iii) aligning the antenna to provide line-of-sight connectivity between the communication node at the respective customer location and a communication node at another customer location, (iv) configuring network settings of the communication node at the respective customer location to provide connectivity from the communication node to a data center, and (v) installing a router at the customer location to establish connectivity between the communication node at the customer location and the wireless communication mesh network.

13. A method comprising:
obtaining potential-customer information related to a set of potential customers for a service to be provided through a wireless communication mesh network in an area of interest (AOI), wherein the potential-customer information comprises both (i) information related to potential customers that are identified during a pre-marketing phase and (ii) information related to potential customers that are identified during a door-to-door marketing phase, and wherein the set of potential customers have a corresponding set of customer locations in the AOI;
evaluating the obtained potential-customer information and thereby identifying a subset of customer locations at which to deploy the wireless communication mesh network; and
generating and outputting information that facilitates deployment of the wireless communication mesh network at the identified subset of customer locations in the AOI.

14. The method of claim 13, wherein the AOI for the wireless communication mesh network is identified based on leads generated during the pre-marketing phase.

15. The method of claim 13, wherein the AOI for the wireless communication mesh network is identified based on one or more of (i) availability of fiber connectivity at a reasonable cost, (ii) level of vegetation, (iii) population density, (iv) demographics, or (v) average annual household income.

16. The method of claim 13, wherein the pre-marketing phase comprises one or more of a social media or online marketing phase, a radio and television marketing phase, or a mailer-based marketing phase.

17. The method of claim 13, wherein evaluating the obtained potential-customer information and thereby identifying the subset of customer locations at which to deploy the wireless communication mesh network comprises:
evaluating one or more of a line-of-sight profile, a vegetation profile, a number of hops, a length of link, a target-market-penetration rate, a number of service tiers, or a number of technology tiers associated with each customer location included in the set of customer locations; and
based on the evaluating, rejecting certain customer locations in the set of customer locations and then identifying each remaining customer location in the set of customer locations as a customer location to include in the subset of customer locations.

18. The method of claim 17, wherein identifying the rejected potential customers as candidates for a different tier of the service to be provided through the wireless communication mesh network that is defined by a different type of wireless-communication-mesh-network technology, a different Service Level Agreement (SLA), or a different pricing model.

19. A computing system comprising:
a network interface;
at least one processor;
a non-transitory computer-readable medium; and
program instructions stored on the non-transitory computer-readable medium that are executable by the at least one processor such that the computing system is configured to:
obtain potential-customer information related to a set of potential customers for a service to be provided through a wireless communication mesh network in an area of interest (AOI), wherein the potential-customer information comprises both (i) information related to potential customers that are identified during a pre-marketing phase and (ii) information related to potential customers that are identified during a door-to-door marketing phase, wherein the set of potential customers have a corresponding set of customer homes in the AOI, and wherein the potential-customer information comprises a respective line-of-sight (LOS) profile for a roof overhang of each customer home in the set of customer homes;
based at least in part on the respective LOS profiles for the roof overhangs of the set of customer homes, identify a subset of customer locations at which to deploy the wireless communication mesh network; and
generate and output information that facilitates deployment of the wireless communication mesh network at the identified subset of customer locations in the AOI.

20. A communication system comprising:
a set of wireless communication mesh network nodes that are configured to form a wireless communication mesh network, wherein each of at least a subset of the wireless communication mesh network nodes in the set of wireless communication mesh network nodes comprises a customer home having wireless communication mesh network equipment installed on a roof overhang of the customer home.
